(19) United States
(12) Patent Application Publication
(10) Pub. No.: US 2016/0148266 A1
(43) Pub. Date: May 26, 2016

(54) CONSUMER INTERACTION FRAMEWORK FOR DIGITAL SIGNAGE

(71) Applicant: THOMSON LICENSING, Issy de Moulineaux (FR)

(72) Inventors: JEFFREY DALE HOLLAR, LIVERMORE, CA (US); SCOTT ARTHUR LEHMAN, FOSTER CITY, CA (US)

(73) Assignee: THOMSON LICENSING

(21) Appl. No.: 14/850,681

(22) Filed: Sep. 10, 2015

Related U.S. Application Data
(60) Provisional application No. 62/085,232, filed on Nov. 26, 2014.

(51) Int. Cl. G06Q 30/02; H04M 1/02; H04W 4/02

(52) U.S. Cl. CPC G06Q 30/0261; H04W 4/02; H04M 1/0202; G06Q 30/0267; G06Q 30/0269

(57) ABSTRACT

Ways to provide media content are described. Advertising displays (120) may be able to interact with at least one mobile device (110) using an application framework (165). The framework may be able to notify the display when the mobile device is within an area (220) associated with the display. The display may update content based on the notification. In addition, the display may update a knowledge base, based on the notification. The display may update media content based on the knowledge base. The display may provide a set of menu options to the mobile device framework which may, in turn, provide the menu to a user interface element of the mobile device. The framework may identify a selection from the set of menu options and send a message to the display indicating the selection. The display may update the media content based at least partly on the selection.

### BACKGROUND

Retailers use in-store advertising to help influence consumer behavior and promote purchases. Current solutions may detect consumer presence or allow interaction via touchscreens or kiosks used as part of a signage system. Some systems may use motion detection or machine vision to detect consumer presence and allow consumer interaction via gestures or movement. Such solutions require additional hardware (e.g., touchscreens, cameras, etc.), thus increasing installation and maintenance costs for a system.

Current solutions are not able to provide real-time profiling of consumers within an establishment or venue, instead relying on statistical surveys that are expensive to conduct regularly and must extrapolate across long periods of time which reduces accuracy. Analysis performed using cameras and machine vision to determine specific features of the people in the environment, such as age and gender, requires additional hardware and sophisticated algorithms. Such solutions are still unable to gather deeper demographic or psychographic data.

Dedicated mobile applications for digital signage systems would require users to download a specialized application and share personal data. In addition, such applications require users to “check-in” or otherwise take action in order to engage the application features.

Thus there is a need for a mobile device framework that allows creation of mobile device applications that automatically interact with digital signage systems without requiring a user to perform any affirmative actions.

### SUMMARY

Some embodiments allow consumers to interact with a signage system using a mobile device (e.g., a smartphone). Such consumers may be associated with a system display (and/or relative to other appropriate system elements) based at least partly on a location of each consumer relative to the display.

The consumer interaction may include both direct and indirect interaction with digital signage systems. Such direct interaction may include providing a set of control options to at least one consumer and receiving one or more commands from the consumer. Indirect interaction may include sharing data about the consumer(s) and their intent when they enter a retail environment, which can then be used to intelligently select appropriate advertisements to play. By building this functionality into a mobile application framework, the functionality may be integrated into multiple third party applications.

In some embodiments, consumer location may be determined using a mobile device associated with each consumer. Such a mobile device may be able to interact with the signage system via a mobile application framework of some embodiments.

The framework may be integrated into mobile operating systems. A software development kit (SDK) including the framework may be provided to application developers such that framework elements may be included in various mobile applications (e.g., retailer applications). The framework may allow retailers (or other appropriate parties) to easily identify and automatically launch user installed applications via notifications, for example, or web based applications without the need for users to manually and intentionally launch the application or perform other affirmative actions (such as scanning a quick recognition (QR) code using a mobile device) to interact with signage and/or receive promotions.

In some embodiments, a consumer is able to interact or receive promotional rewards without requiring the consumer to perform an action such as launching an application or scanning a code. Instead, that functionality may be included in the application by a retailer-developer using the framework SDK of some embodiments. In this way, when a consumer walks into an establishment, the consumer may receive a notification, for example, that alerts the consumer that he may interact with digital signage or that a promotion or offer is available. In this example, the framework may make use of location services or device registration to detect a particular consumer.

Furthermore, the framework may allow communications with the retailer signage in a way that allows personalization of the advertising shown on the digital signage. For example, if a consumer walks into a retail store and has the retailer application installed on the mobile device, the framework may send personalized information such as shopping lists or purchase history to the retailer system such that personalized and targeted advertising may be shown to the consumer when in the vicinity of a digital display. Such targeted content may be delivered without requiring the consumer to take any action (e.g., the mobile device may be locked and left in the user's pocket).

The preceding Brief Summary is intended to serve as a brief introduction to various features of some exemplary embodiments. Other embodiments may be implemented in other specific forms without departing from the scope of the disclosure. The Detailed Description that follows and the Drawings (or “Figures” or “FIGs.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of a signage system according to an exemplary embodiment;

FIG. 2 illustrates a schematic block diagram of an establishment system of some embodiments implemented using the framework of FIG. 1;

FIG. 3 illustrates a schematic block diagram of a multi-establishment system of some embodiments;

FIG. 4 illustrates a flow chart of a conceptual client-side process used by some embodiments to allow control of signage content;

FIG. 5 illustrates a flow chart of a conceptual server-side process used by some embodiments to allow control of signage content;

FIG. 6 illustrates a flow chart of a conceptual client-side process used by a framework of some embodiments to allow interaction among a mobile device and digital signage;

FIG. 7 illustrates a flow chart of a conceptual server-side process used by some embodiments to provide signage content based on a set of mobile devices associated with the signage;

FIG. 8 illustrates a flow chart of a conceptual server-side process used by some embodiments to provide content to a mobile device based on association of the device with digital signage; and

FIG. 9 illustrates a schematic block diagram of a conceptual computer system used to implement some embodiments.

### DETAILED DESCRIPTION

The following detailed description describes currently contemplated modes of carrying out some exemplary embodiments. The description is not to be taken in a limiting sense, but is made merely for the purpose of illustrating the general principles of the disclosure, as the scope of the disclosure is best defined by the appended claims.

Various inventive features are described below that can each be used independently of one another or in combination with other features. Broadly, some embodiments generally provide ways to allow consumers to interact with digital signage and/or for signage systems to identify consumers within a target area.

Direct interaction with digital signage systems is typically accomplished using large touchscreens, but such devices are expensive to install and maintain. For some signage applications, mobile devices such as smartphones may be used to eliminate the need for additional installed devices. The mobile devices may be able to execute an application that is able to communicate with digital signage systems.

Mobile devices may also be utilized to provide valuable information about who is actually in the venue and what their intent is, which can be used to indirectly affect the content that is shown. An application running on the mobile device may determine when the user is in the venue (e.g., using geolocation features, via an explicit “check-in” action, etc.) and transmit information to the digital signage system. In retail environments, this data could include the items the customer intends to purchase in the form of a shopping list created using the mobile application. This data can then be used to select the most suitable media to play (e.g., by selecting relevant advertisements).

In either scenario, such functionality may be packaged as a mobile application framework, which can be incorporated into applications (e.g., those already created by owners of retail establishments). Such an approach may provide the benefit of an enhanced user experience without requiring users to download and install a new application.

As one example scenario, the framework may include functionality for selecting media on a TV wall in a retail store, allowing the user to choose a preferred form of content (e.g., sports, movies, nature, etc.) when evaluating different televisions.

When a retailer mobile application including the digital signage framework is opened and the feature is activated, the framework may communicate with the signage system to determine the available content and create a menu which may be provided via the mobile device. When the user makes a selection, the framework may send a command to the signage system which causes the signage system to play the selected category of video on the TV wall. The framework may also retrieve data about the different television models being evaluated, allowing the customer to choose a subset of televisions, view product information, pricing, etc.

As another example scenario, the mobile application framework may determine that a user has entered a retail store, using geolocation services on the mobile device (i.e., “geofencing”) or based on an explicit action by the user (e.g., activating a retailer mobile application to perform a “check-in”, opening a digital shopping list, etc.). The framework may connect to the digital signage system in various appropriate ways (e.g., over a local Wi-Fi network, via a cellular connection, using a Bluetooth link, etc.) and transmit data regarding the user (e.g., demographic information such as age and gender, other data from a user profile such as zip code, a roster of items stored in a shopping list, etc.).

The signage system may use the received data, collected from multiple users in a venue, to build an aggregate profile of the consumers. Such a profile may include psychographic data derived from the collected consumer data. That information may be fed into a rules system that decides which media content (e.g., which advertisements) would be most effective and/or appropriate. Knowledge of the items in a user shopping list may allow special offers to be delivered to the user on the mobile device to entice the user to, for instance, purchase a specific brand of a listed product.

A first exemplary embodiment provides a method for controlling content provided by a digital signage system. The method includes monitoring a location of a mobile device, sending, from the mobile device, a notification to the digital signage system if the location of the mobile device is within an area associated with the digital signage system, receiving, at the mobile device, a response to the notification from the digital signage system, and sending, from the mobile device, a termination message to the digital signage system if the location of the mobile device is outside the area associated with the digital signage system.

A second exemplary embodiment provides an apparatus that provides controllable media content. The apparatus includes a mobile device having a geolocation sub-element able to determine a location of the mobile device, a framework that is able to monitor the location of the mobile device, determine whether the mobile device is within an area associated with a display of a digital signage system, send, to the display, a notification if the mobile device is within the area associated with the display, receive, from the display, a response to the notification, and send, to the display, a termination message if the mobile device is outside the area associated with the display.

A third exemplary embodiment provides a method for providing advertising content via a digital signage system. The method includes providing media content from at least one display associated with the digital signage system, receiving a notification, from a mobile device, indicating that the mobile device is within an area associated with the at least one display, where the notification includes data related to a user of the mobile device, updating a knowledge base based at least partly on the notification, and providing updated media content based at least partly on the updated knowledge base.

A fourth exemplary embodiment provides a digital signage system that provides advertising content. The digital signage system including a storage that stores media content, a memory that stores at least one set of instructions, where the at least one set of instructions are for providing media content from at least one display associated with the digital signage system, receiving a notification, from a mobile device, indicating that the mobile device is within an area associated with the at least one display, where the notification includes data related to a user of the mobile device, updating a knowledge base based at least partly on the notification, and providing updated media content from the at least one display based at least partly on the updated knowledge base.

Several more detailed embodiments are described in the sections below. Section I provides a conceptual description of system architectures used by some embodiments. Section II then describes methods of operation used by some embodiments. Next, Section III describes several example usage scenarios enabled by some embodiments. Lastly, Section IV describes a computer system which implements some of the embodiments.

### I. System Architecture

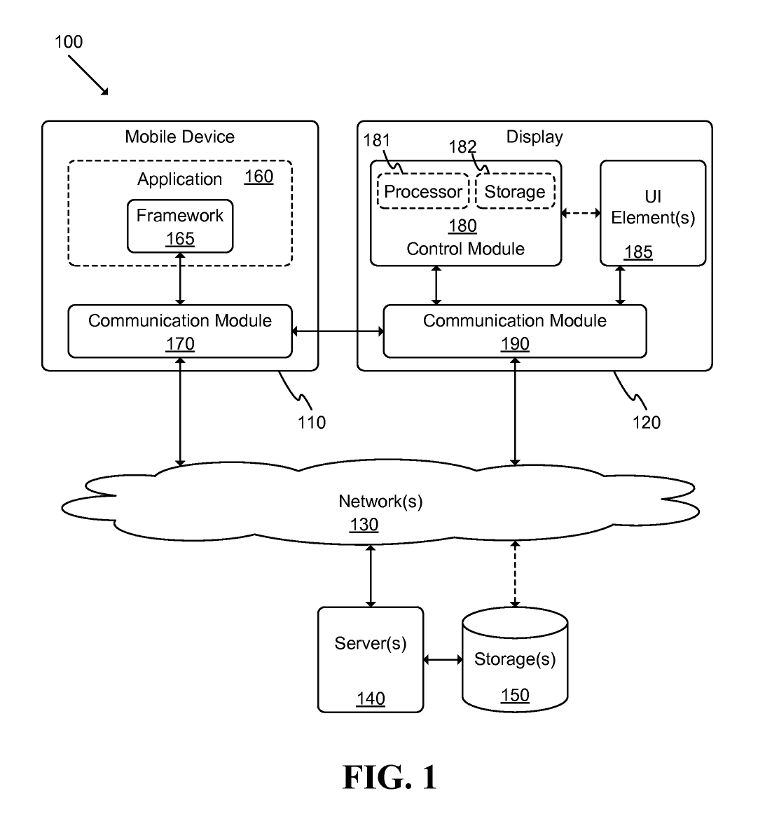

FIG. 1 illustrates a schematic block diagram of a signage system 100 according to an exemplary embodiment. As shown, the system may include a mobile device 110, display or display 120, network(s) 130, server(s) 140, and storages 150. The mobile device 110 may include one or more applications 160, a framework 165, and a communication module 170. The display 120 may include a control module 180, one or more UI elements 185, and a communication module 190.

The mobile device 110 may be any user device able to communicate with external devices (e.g., a smartphone, a tablet, a notebook PC, etc.). Such a device may include various user interface elements (e.g., a touchscreen, keyboard or keypad, microphone, speaker, motion sensing elements, haptic feedback elements, etc.). In addition, the device may include various processing elements, storages, interfaces, etc. The device may be able to execute various applications 160 that may be able to interact with other elements of system 100 via framework 165.

The framework may allow interaction with the display 120 via a direct connection (e.g., a local wireless connection such as Bluetooth or Wi-Fi) or indirect connection (e.g., via one or more networks, servers, and/or other appropriate resources). Such interaction may include, for example, transmitting consumer information to the signage system, receiving product information from the signage system, receiving available options from the signage system, transmitting commands or messages to the signage system, etc.

The framework 165 may also interface to various mobile device 110 sub-elements. Such sub-elements may include hardware elements (e.g., wireless transmission elements, user interface elements, etc.) and/or software elements. Such sub-elements may include hardware and/or software elements that are able to determine the location of the mobile device (e.g., global positioning system (GPS) elements, triangulation software, etc.).

One of ordinary skill in the art will recognize that the framework 165 is conceptual in nature and not necessarily distinct from the application 160. For instance, some embodiments may provide an SDK that allows retailers to embed the framework functionality into a stand-alone application, where the executable application code may include framework elements and/or other elements. In some embodiments, the framework may be included in a mobile operating system that is accessible to mobile applications (e.g., using function calls, via an application programming interface (API), etc.).

Communication module 170 may allow the mobile device 110 to communicate using network 130 (and/or other appropriate resources). The communication module 170 and/or any associated interfaces may include various hardware elements able to communicate using defined protocols over various appropriate paths (e.g., network 130).

The display 120 may be an electronic device that is able to provide video content to a user. The display 120 may be an “end-cap display”, a shelf display, a free standing device, a television, monitor, and/or any other appropriate implementation.

The control module 180 may at least partly control content provided to the UI element 185. Such a UI element may include output elements such as video outputs (e.g., display screens or monitors, touch screens, etc.), audio outputs (e.g., speakers), other presentation elements such as lights or motion, etc.). The control module 180 may be associated with a local storage 182 that provides media content to the display 185. In addition, the control module 180 may include a component such as a processor 181 that may be able to receive inputs, process commands, instructions, and/or data, and/or otherwise be able to control the operation of the display 120.

Communication module 190 may allow the display 120 to communicate using network 130 (and/or other appropriate resources). The communication module 190 and/or any associated interfaces may include various hardware elements able to communicate using defined protocols over various appropriate paths (e.g., network 130). As shown, in some embodiments, the mobile device 110 and display 120 may be able to communicate directly without use of network 130 (e.g., via a Bluetooth connection).

Network(s) 130 may allow the mobile device 110 and/or display 120 to communicate with one or more servers 140 and/or storages 150. In this way, the mobile device 110 and/or display 120 may be able to send commands or other information to the server 140 and/or storages 150. Likewise, the server 140 may be able to send commands or information to the mobile device 110 and/or display 120. Such networks 130 may include networks such as wired networks (e.g., Ethernet), wireless networks or communication channels (e.g., Wi-Fi, Bluetooth, etc.), cellular networks, etc.

During operation, the display 120 may typically display content associated with a playlist or loop of clips. In addition to the content itself, such a loop may include attributes associated with various display options (e.g., time between clips, fade operations between clips, number of times to repeat a clip, etc.). Such a loop may be pre-defined in various appropriate ways (e.g., via a server interface, using an interactive display of some embodiments, etc.).

As the loop plays, the display 120 may monitor an area for mobile devices 110. If a mobile device interacts with the display 120 (e.g., by sending a notification that the mobile device is within the area, by responding to a query from the signage system, etc.), the media content presented by the signage may be updated based on the presence of the mobile devices 110, data associated with users of the devices, and/or other relevant factors.

For instance, the display 120 may receive (or retrieve from a server or other resource) information related to the users and update the media content based on relevant demographic information (e.g., average age of the users, education, etc.). As another example, the signage may interact with a specific user device and provide a list of available options from which a user may select. The presented content may then be updated based on one or more commands received from the specific user device.

In some cases, the display 120 may be able to identify an administrative or otherwise privileged user associated with mobile device 110. When such a user is identified, a menu or other appropriate interface may be provided via the mobile device such that the user may be able to override and update various settings. For instance, the user may be able to include different content, update loop or clip attributes, remove content, etc.

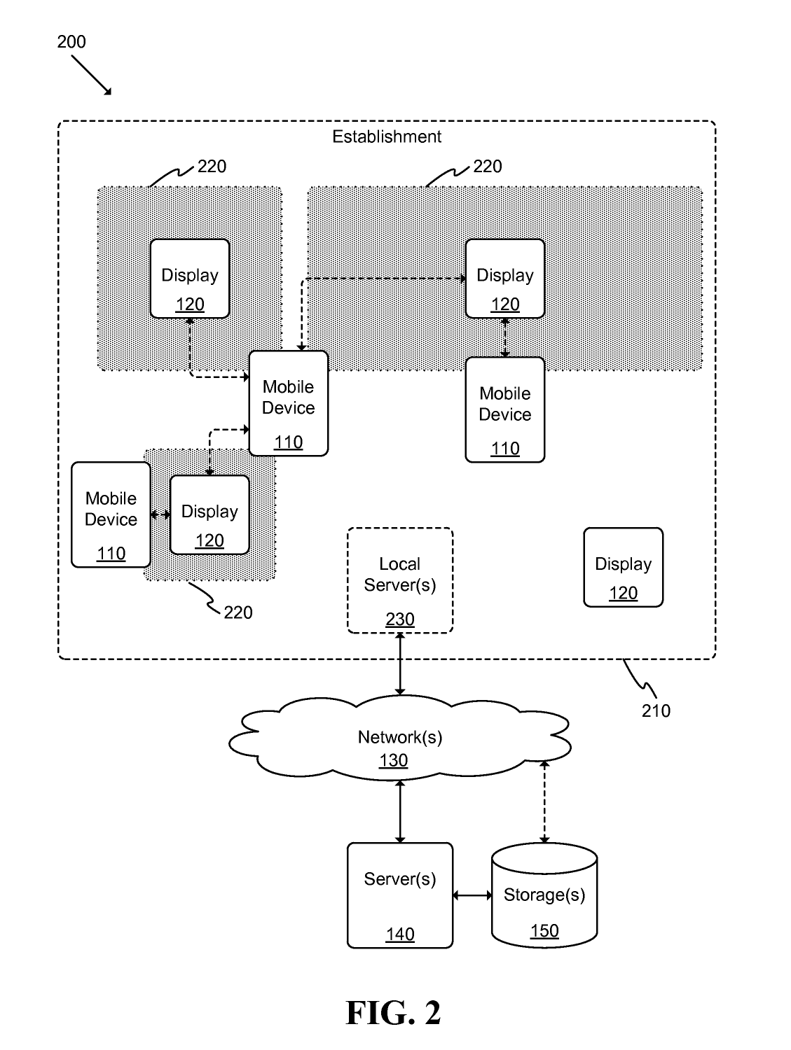

FIG. 2 illustrates a schematic block diagram of an establishment system 200 of some embodiments implemented using framework 165. As shown, the system 200 may include a set of mobile devices 110, an establishment 210 having a set of displays 120, each with an associated area 220, a local server 230, one or more networks 130, one or more servers 140, and one or more storages 150.

In the example of FIG. 2, the elements may represent locations on a two-dimensional representation of a physical area. One of ordinary skill in the art will recognize that different physical locations may have different specific attributes and/or different specific types of areas. For instance, a single store may include multiple levels where some areas are associated with a single level and other areas span multiple levels (e.g., when a display is visible from an escalator or elevator).

An establishment 210 may represent a physical location or structure (e.g., a retail store) or section thereof (e.g., an area within a department store or grocery store). Each establishment may be defined in various appropriate ways (e.g., using a set of geographic coordinates).

The areas 220 associated with the displays 120 may have various different configurations. For instance, different areas 220 may be differently sized, shaped, oriented, etc. One area may encompass a physical location (e.g., a store) that includes one or more sub-areas (e.g., signage associated with sections within the store). Areas may overlap partially or completely. In some embodiments a single area may be associated with multiple displays 120. In addition, a single signage may be associated with multiple areas 220.

Each display 120 may be associated with multiple mobile devices 110 within the area associated with the display 120. Likewise, each mobile device 110 may be associated with multiple displays 120.

Some embodiments may include a local server 230 that is able to interact with the displays 120 associated with the establishment 210. Such a local server 230 may be able to access one or more local storages (not shown). In some embodiments, the displays 120 may communicate with the local server 230 over a local network (not shown), with the local server providing a communication path from the displays 120 to the servers 140 and/or storages 150. In some embodiments, the displays 120 may be able to communicate directly over network 130 without using a local server 230.

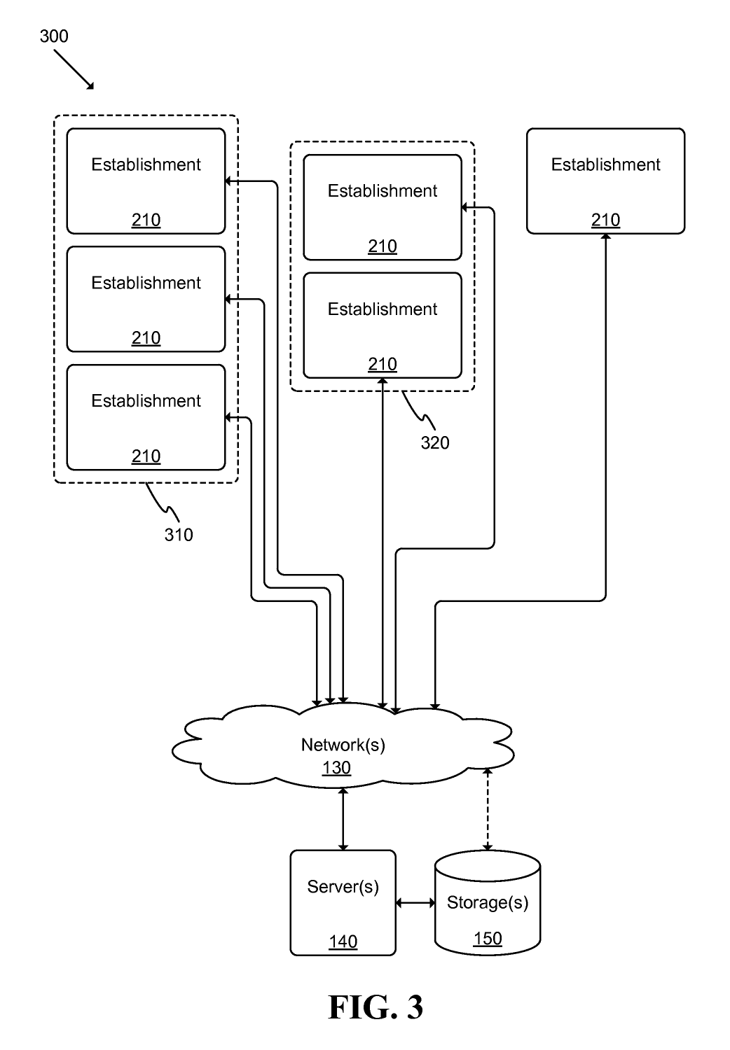

FIG. 3 illustrates a schematic block diagram of a multi-establishment system 300 of some embodiments. In this example, the establishments 210 are grouped into a single establishment 210, a first set of establishments 310, and a second set of establishments 320.

In some embodiments, establishments 210 may be included in multiple groups or sets (e.g., a first group may include retailers that sell a first product while a second group may include retailers that sell a second product, where some retailers sell both products).

A set of establishments may be associated based on various applicable criteria. For instance, establishments associated with a chain may be grouped together. As another example, types of establishments may be grouped together (e.g., grocery stores, clothing stores, etc.).

In some embodiments a single physical location (e.g., a department store, a mall, etc.) may be represented as a set 310 of establishments 210, where each establishment in the set 310 represents a section of the physical location (e.g., a department within the store, a store within the mall, etc.).

Different users may utilize different sets of establishments 210. For instance, a user associated with a retail chain may organize establishments representing each store in the chain by utilizing sets based on region, while a user associated with selling a product through that chain may be presented with a set of establishments where each retail chain is represented as a single establishment.

System 300 may allow content providers to efficiently distribute content and/or provide updates or commands to appropriate recipients.

One of ordinary skill in the art will recognize that systems 100, 200, and 300 of FIGS. 1-3 are conceptual in nature and different embodiments may be implemented in various different ways without departing from the scope of the disclosure. For instance, different embodiments may include different communication paths, may include additional elements, may omit some elements, etc.

### II. Methods of Operation

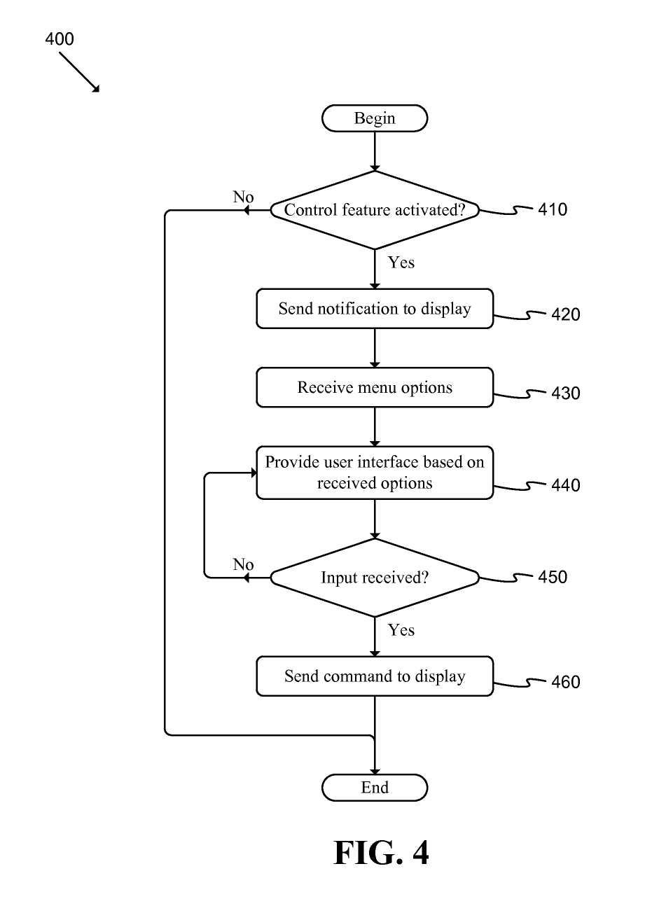

FIG. 4 illustrates a flow chart of a conceptual client-side process 400 used by some embodiments to allow control of signage content. Such content may be provided by signage similar to display 120 described above. The process may be executed by a mobile device utilizing the framework of some embodiments such as mobile device 110 described above.

Process 400 may begin, for instance, when a mobile device is located within an area associated with a digital signage system (and/or other controllable systems or devices). The framework of some embodiments may retrieve the device location from a mobile device geolocation sub-system. The location may be used to determine whether the mobile device location is within the area associated with the system.

As shown, the process may determine (at 410) whether a control feature has been activated. Such a determination may be made in various appropriate ways. For instance, the process may determine whether a flag or other indicator has been set by a user or application. The indicator may be set based on user selections, application settings, and/or other relevant factors (e.g., whether a retailer application is currently running).

If the process determines (at 410) that the control feature has not been activated, the process may end. If the process determines (at 410) that the control feature has been activated, the process may then send 420 a notification to the display. Such a notification may be sent by the framework of some embodiments. The notification may be sent over various appropriate pathways (e.g., via a network, server, wireless link, etc.). The notification may include data regarding the user (e.g., login information, profile data, a shopping list, etc.), data regarding application status (e.g., whether a retailer application is currently active, whether the mobile device is locked, etc.), and/or other relevant information.

In addition, some embodiments may notify the user that the control feature is available for use with the signage system. The notification may be “pushed” to the mobile device such that the user receives the notification independently of any user action. Such a notification may include an audio tone, vibration, and/or other appropriate signals.

Next, the process may receive (at 430) a set of menu options. Such options may be selected based on various relevant factors (e.g., available content, user data, etc.). The set of menu options may be received directly from the signage system, via a server and network, and/or other appropriate ways. The menu options may include specific content items (e.g., media clips, graphic displays, etc.), categories of content (e.g., sports, entertainment, home and garden, etc.), and/or other appropriate items.

In some cases, the notification may identify the user as an administrator (or other such user) and the menu options may reflect administrative options. For instance, an administrator may wish to modify a playlist to include different clips, change the order clips are played, temporarily override a playlist to promote a particular item, etc.

The process may then provide (at 440) a user interface based at least partly on the set of menu options. For instance, a mobile device display may be used to show thumbnails or other appropriate representations of content items. As another example, a mobile device touchscreen may be used to provide a set of selectable buttons or controls. Such buttons may represent, for instance, categories of content, survey selections, etc. Controls may include, for example, next, previous, pause, etc.

Next, the process may determine (at 450) whether an input has been received. Such a determination may be made in various appropriate ways. For instance, the process may determine whether a user has selected a touchscreen region associated with a content item, button, control, and/or other appropriate element.

If the process determines (at 450) that no input has been received, the process may repeat operations 440-450 until the process determines (at 450) that an input has been received.

If the process determines (at 450) that an input has been received, the process may then send (at 460) a command message to the display and then end. Such a command message may be sent using various appropriate communication pathways. The command message may be generated and/or sent by the framework of some embodiments. The command message may include a selection of a content item, a command associated with a button or other control feature, and/or other appropriate elements.

In some embodiments, the command message may include a request for information. For instance, the message may include a request for a list of available brands for a particular product. As another example, the message may request pricing for available products. In such cases, the process may then receive a response to the request before ending.

In some embodiments, operations 430-460 may be performed iteratively. In this way, a user may be provided with updated menu options after making a selection (or make multiple selections from a static set of options such as when using video player controls to play, pause, search, stop, or skip media). In such cases, the process may end based on a determination that some criteria has been met (e.g., that a user has closed an application, that the mobile device is no longer communicating with the signage, etc.).

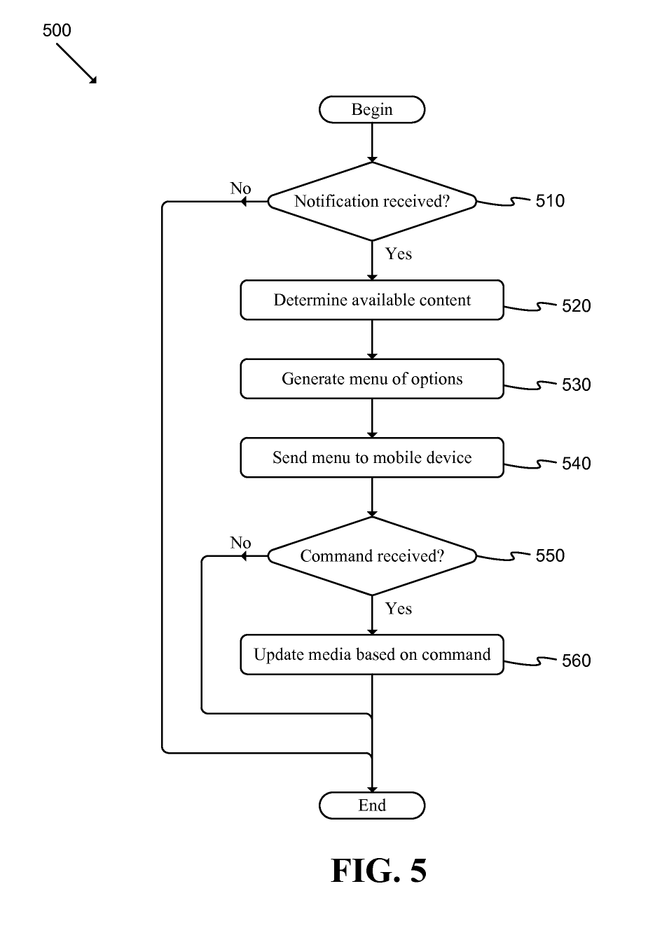

FIG. 5 illustrates a flow chart of a conceptual server-side process 500 used by some embodiments to allow control of signage content. Such content may be provided by signage similar to display 120 described above. The process may be executed by a server in some embodiments such as server 140 described above. Alternatively or conjunctively, the process may be executed by an element of a signage system such as display 120 described above. Process 500 may begin, for instance, when a signage display or server is powered on. The signage may provide default content (e.g., a playlist of clips) when process 500 begins.

As shown, the process may determine (at 510) whether a notification has been received. Such a notification may be sent by a mobile device and received directly at the signage or via one or more networks and/or servers of the signage system. The notification may include information related to the mobile device (e.g., screen size, available inputs and outputs, etc.), the mobile device user (e.g., biographic data, demographic data, shopping lists, etc.), and/or other relevant information (e.g., application status, mobile device status, etc.).

If the process determines (at 510) that no notification has been received, the process may continue to provide the default content and then end. If the process determines (at 510) that a notification has been received, the process may then determine (at 520) available content. Such a determination may be made in various appropriate ways. For instance, a signage display may retrieve a listing of content stored locally at the display. As another example, a server may retrieve a listing of content from a storage or other appropriate resource. As still another example, the signage and server may, in conjunction, generate a listing of available content that includes content stored locally at the signage and/or content accessible to the server.

Process 500 may then generate (at 530) a menu of options based at least partly on the available content. The menu of options may include, for instance, a listing of content items, sets of control features (e.g., commands associated with play, next, previous, etc.), selectable categories, and/or other relevant options.

The process may then send (at 540) the menu of options to the mobile device. The menu may be sent using various appropriate communication pathways and may be formatted such that the framework of some embodiments is able to identify the options at the mobile device.

Next, the process may determine (at 550) whether a command message has been received. If the process determines (at 550) that no command message has been received, the process may end.

If the process determines that a command message has been received, the process may then update (at 560) media provided by the signage based at least partly on the received command message and then may end. The process may decipher the received command message to identify a command, selection, or other appropriate message content. The media update may be based on the identified content of the message (e.g., skipping to the next clip in a list when a “next” command is identified, proceeding to a particular clip when a selection of that clip is received, etc.).

In some embodiments, operations 520-560 may be performed iteratively. In this way, updated menu options may be generated after each command message is received (or additional commands may be received from among a static set of options such as when using video player controls to play, pause, search, stop, or skip media). In such cases, the process may end based on a determination that some criteria has been met (e.g., a termination message is received from the mobile device, no command messages are received for a particular time period, etc.). In addition, before ending, the process may revert to the default media selection.

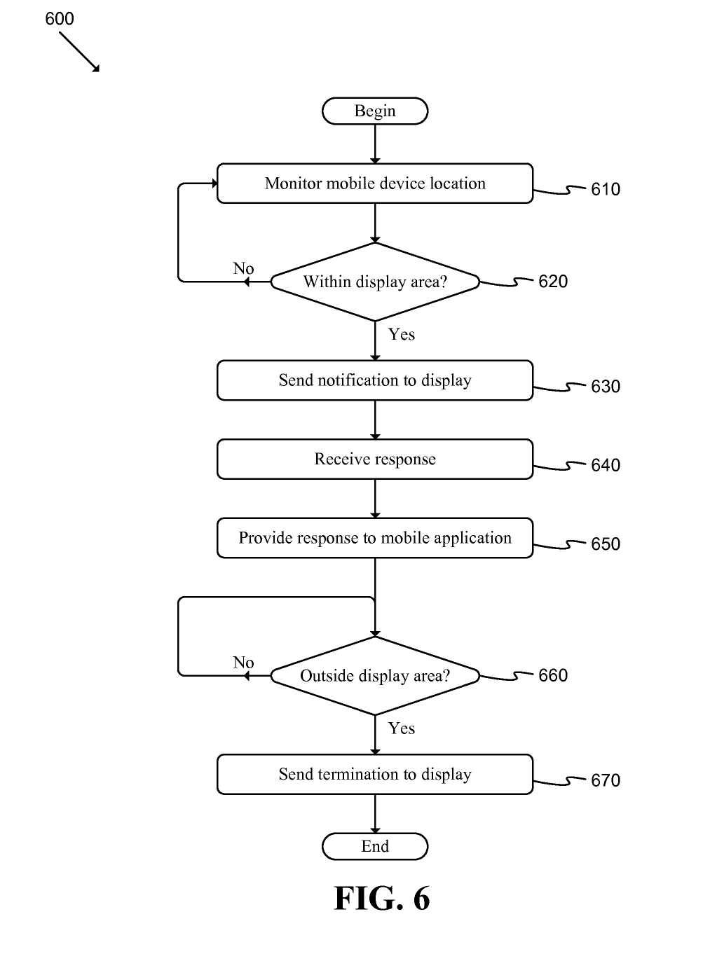

FIG. 6 illustrates a flow chart of a conceptual client-side process 600 used by a framework of some embodiments to allow interaction among a mobile device and digital signage. The process may be executed by a mobile device utilizing the framework of some embodiments such as mobile device 110 described above. The process may allow the mobile device to interact with signage similar to display 120 described above. The process may begin, for instance, when a mobile device is powered on.

As shown, the process may monitor (at 610) the mobile device location. The framework of some embodiments may interact with geolocation services of the mobile device to determine the current location of the device.

Next, the process may determine (at 620) whether the mobile device is within the area associated with a display. As described above in reference to system 200, each display may have an associated area. The areas may be accessible to the mobile device (e.g., via a retailer application, via a server and storage, etc.). The process may be able to compare the current location with the display areas and determine (at 620) whether the location is within any such area. Alternatively, the process may determine (at 620) that the mobile device is within the area based on other relevant criteria (e.g., user actions such as “check-in”, network or communication link connectivity, etc.).

If the process determines (at 620) that the device is not within the display area, the process may repeat operations 610-620 until the process determines (at 620) that the device is within range. If the process determines (at 620) that the device is within range, the process may send (at 630) a notification to the display. Such a notification may be similar to that described above in reference to operation 420.

Next, the process may receive (at 640) a response to the notification message. Such a response may include, for instance, a list of menu options as described above in reference to process 400, offers associated with items in a shopping list, etc. The response may include data regarding available products, manufacturers, pricing, etc.

The process may then provide (at 650) the response to the mobile application via the framework of some embodiments. In some embodiments, the framework may decode or decipher the response before providing appropriate data to the mobile application.

In some embodiments, operations 630-650 may be performed iteratively, depending on various appropriate factors (e.g., user selection, message content, available options, etc.).

Next, the process may determine (at 660) whether the device is outside the display area. Such a determination may be made by monitoring and comparing the current location of the mobile device to the display areas as described above. In some embodiments, process 600 may retrieve location information continuously, at regular intervals, and/or based on some relevant criteria (e.g., elapsed time since a message was sent or received, based on a user selection, etc.).

If the process determines (at 660) that the device is not outside the display area, the process may perform operation 660 until the process determines (at 660) that the device is outside the display area. If the process determines (at 660) that the device is outside the display area, the process may then send (at 670) a termination message to the display and then may end.

One of ordinary skill in the art will recognize that process 600 (or portions thereof) may be performed in conjunction with process 400 (or portions thereof) described above. For instance, process 400 may begin if process 600 determines (at 620) that the mobile device is within range of the signage. As another example, process 600 may, instead of including operations 640-650, include operations such as operations 430-460 in order to allow a consumer to control the signage system while within range.

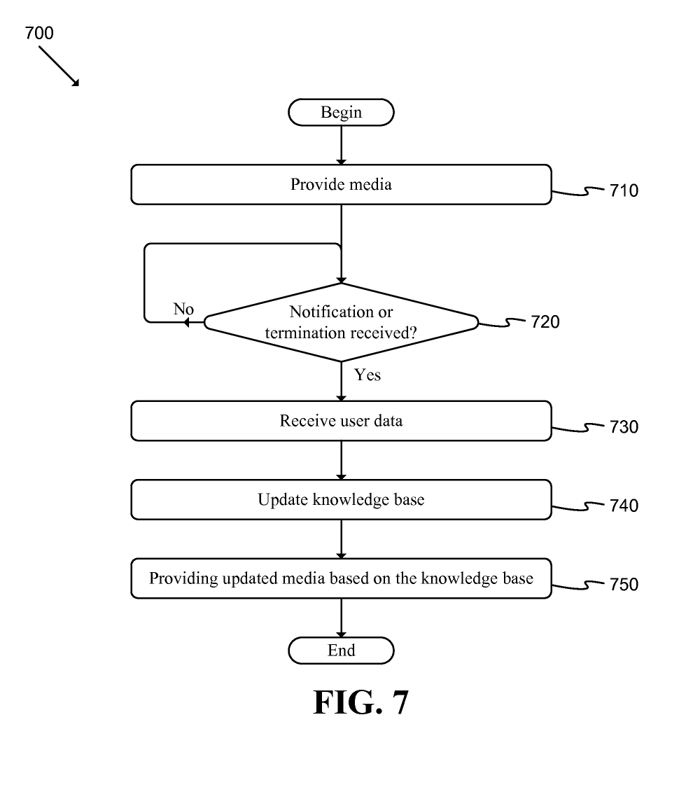

FIG. 7 illustrates a flow chart of a conceptual server-side process 700 used by some embodiments to provide signage content based on a set of mobile devices associated with the signage. Such content may be provided by signage similar to display 120 described above. The process may be executed by a server in some embodiments such as server 140 described above. Alternatively or conjunctively, the process may be executed by a signage such as display 120 described above. Process 700 may begin, for instance, when a signage or server is powered on.

As shown, the process may provide (at 710) media. Such media may include, for instance, a default playlist of clips. Next, the process may determine (at 720) whether a notification or termination has been received. Such notifications may be similar to that described above in reference to operation 630. The terminations may be similar to that described above in reference to operation 670. If process 700 determines (at 720) that no notification or termination has been received, the process may repeat operation 720 until the process determines (at 720) that a notification or termination has been received.

If the process determines (at 720) that a notification or termination has been received, the process may then receive (at 730) user data. The data may be received in a separate message or extracted from the received notification or termination. Such user data may include, for instance, profile data, demographic data, shopping list data, purchase history etc. If the process determines (at 720) that a termination has been received, the process may identify the user data associated with the termination message.

Next, the process may update (at 740) the knowledge base. Such an update may include, for instance, adding user data to the knowledge base when a notification is received, or removing user data from the knowledge base when a termination is received. In this way, the signage system may maintain the knowledge base to reflect the group of users currently within range of the signage. This knowledge base may be stored at a local server of the establishment or a remote server via a network, in cases where a remote server manages the knowledge base for the establishment.

The process may then provide (at 750) updated media content based on the collected user data in the knowledge base and then may end. The knowledge base may include various relevant data elements (e.g., user profile information, demographic data, shopping list data, purchase history, etc.). The elements within the knowledge based may depend at least partly on the capabilities of the signage and/or the available content. For instance, if a signage element is used to advertise products associated with a particular demographic, data associated with users outside that demographic may be excluded from the knowledge base (e.g., a display associated with reading glasses may ignore user data associated with users below a certain age threshold).

Process 700 may be performed continuously, at regular intervals, or based on some criteria. In this way, the process may maintain a knowledge base reflecting the current group of users and provide media content based at least partly on the current state of the knowledge base.

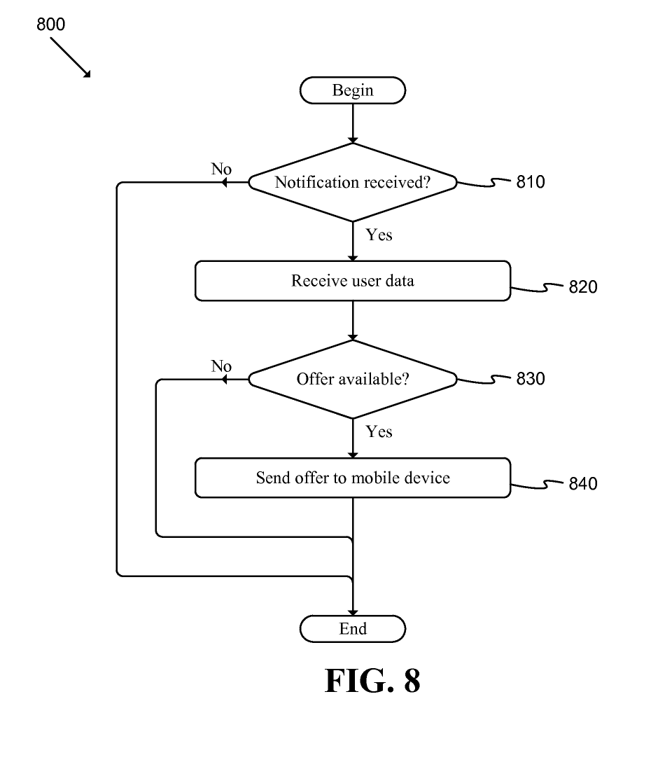

FIG. 8 illustrates a flow chart of a conceptual server-side process 800 used by some embodiments to provide content to a mobile device based on association of the device with digital signage. Such content may be provided by signage similar to display 120 described above. The process may be executed by a server in some embodiments such as server 140 described above. Alternatively or conjunctively, the process may be executed by a signage such as display 120 described above. Process 800 may begin, for instance, when a signage or server is powered on.

As shown, the process may determine (at 810) whether a notification has been received. Such notifications may be similar to that described above in reference to operation 630. If the process determines (at 810) that no notification has been received, the process may end.

If the process determines (at 810) that a notification has been received, the process may then receive (at 820) user data. Such data may be extracted from the notification message, received in response to a query sent to the mobile device, retrieved from a server, and/or otherwise obtained.

In some embodiments, the signage may be able to utilize the framework running on the mobile device to automatically retrieve user data associated with a retailer application such as a shopping list. Such a list may have been previously created using, for instance, a retailer application. The shopping list may include references to specific products (e.g., “brand X toothpaste”), generic items (e.g., “sponges”), etc. In some embodiments, the items in the list may be compared to a roster of items available in an establishment. Such a roster may include information related to, for instance, the location of the items, a list of signage elements associated with the items or locations, etc.

Next, the process may determine (at 830) whether any relevant offers are available. Such a determination may be made in various appropriate ways. For instance, items in a shopping list may be compared to the roster of available items to identify matching items. As another example, the current location of the mobile device may be used to identify offers associated with products positioned near the current location.

If the process determines (at 830) that no relevant offers are available, the process may end. If the process determines (at 830) that a relevant offer is available, the process may send (at 840) the offer to the mobile device and then end. Such an offer may include, for instance, a coupon or other discount, a list of sale items, etc.

One of ordinary skill in the art will recognize that processes 400, 500, 600, 700, and 800 of FIGS. 4-8 may be implemented in various different ways without departing from the scope of the disclosure. For instance, different embodiments may perform the operations in a different order than shown, perform additional operations, and/or omit various operations. As another example, each process may be divided into a set of sub-processes and/or included as part of a larger macro-process. As still another example, various processes (or portions thereof) may be performed iteratively, at regular intervals, etc. In addition, several processes may be performed in parallel. Furthermore, each of the processes may utilize the framework of some embodiments to allow communication among the mobile devices and signage systems.

### III. Example Usage Scenarios

Several example scenarios are laid out below to illustrate various use cases of the resources provided by some embodiments. One of ordinary skill in the art will recognize that many other scenarios may be implemented.

In a first example scenario, a consumer may enter profile information and a shopping list into a retailer application. The consumer may then enter an establishment associated with the retailer. The framework of some embodiments may detect that the location of the user is within the establishment. The framework may then send selected user profile data and/or the shopping list to a signage system associated with the establishment. The signage system may update a knowledge base with the received user data. The signage system may select advertisements based at least partly on the updated knowledge base. In addition, the signage system may identify a coupon or offer associated with at least one item on the shopping list and send the coupon to the framework. The framework may store the coupon in a digital wallet which is accessible to the retailer application. The consumer may then open the shopping list within the retailer application, whereby the framework automatically displays the coupon, allowing the user to redeem the coupon when completing a purchase. The user may then leave the establishment. The framework may detect that the location of the user is outside the establishment and remove data associated with that user from the knowledge base.

In a second example scenario, the framework may include functionality for selecting media on a TV wall in a retail store. A consumer may receive a notification on their mobile device when within a target area or alternatively open a retailer application that communicates with the framework of some embodiments. The consumer may then activate a control feature that uses the framework to communicate with the signage system. The framework may retrieve available options from the signage system and provide the options to the consumer as a list of selectable elements (and/or using other appropriate user interface elements). Such available options may include categories (e.g., sports, comedy, etc.), specific content items (e.g., clips from movies, TV shows, etc.), or other appropriate options (e.g., type of content such as high-definition or standard definition). When the user selects an option, the framework may send a message based on the selection to the signage system. The signage system may then update the displayed content based on the received message. In some cases, the framework may also retrieve product information regarding the TVs, thus allowing the consumer to make selections based on various appropriate parameters (e.g., manufacturer, price, etc.). In some cases, such selections may present content on a sub-set of the available TVs (e.g., only TVs for sale under a price threshold set by the consumer).

In a third example scenario, a user may carry a mobile device that includes the framework of some embodiments into an establishment. The framework may determine that the consumer has entered the establishment and may send a notification to a digital signage system associated with the establishment. Content provided by the signage system may be automatically updated based on the notification, without requiring any action from the user.

In a fourth scenario, a user may be in a mall having several different establishments while carrying a mobile device that includes the framework of some embodiments. The framework may determine when the user has walked in and out of one establishment to another. In some embodiments, when a shopping list of the user is retrieved via the framework, the user may be provided with coupons associated with certain products. The user may also be provided with general promotions/coupons when no shopping list. Additionally, the user may also be presented with a list of multiple establishments at the mall that carry a specific product so the user may comparison shop, along with any coupons or promotions are available for that product. Some applications may even be able to provide, via a network or over the internet, current pricing of a particular product at the multiple establishments.

In all the above described scenarios, the framework provides the benefits of an enhanced consumer experience that does not require the consumer to perform an action such as launching an application or scanning a code, allows the user to receive relevant promotions/offers/advertisements/coupons, and effectively control digital signage via their mobile device.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

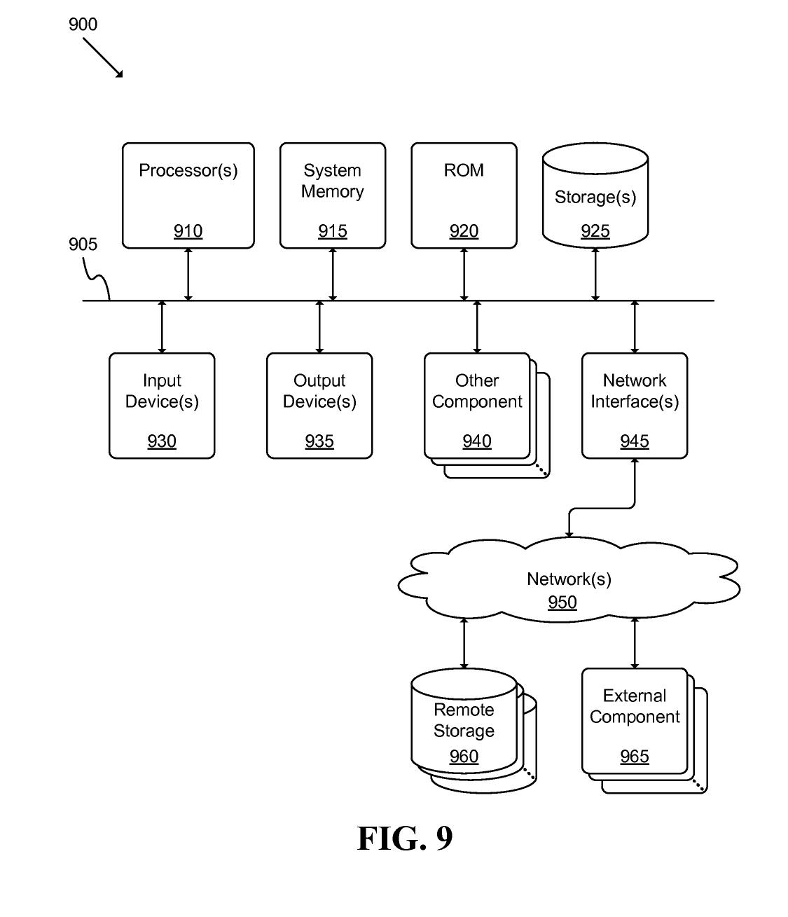

FIG. 9 illustrates a schematic block diagram of a conceptual computer system 900 used to implement some embodiments. For example, an interactive display, motion sensing/gesturing device or elements, or local and/or remote servers may be implemented using one or more components of a computer system as described in FIG. 9. More specifically, the systems described above in reference to FIGS. 1-3 may be at least partially implemented using computer system 900. As another example, the processes described in reference to FIGS. 4-8 may be at least partially implemented using sets of instructions that are executed using computer system 900.

Computer system 900 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 900 may include at least one communication bus 905, one or more processors 910, a system memory 915, a read-only memory (ROM) 920, permanent storage devices 925, input devices 930, output devices 935, various other components 940 (e.g., a graphics processing unit), and one or more network interfaces 945.

Bus 905 represents all communication pathways among the elements of computer system 900. Such pathways may include wired, wireless, optical, and/or other appropriate communication pathways. For example, input devices 930 and/or output devices 935 may be coupled to the system 900 using a wireless connection protocol or system.

The processor 910 may, in order to execute the processes of some embodiments, retrieve instructions to execute and/or data to process from components such as system memory 915, ROM 920, and permanent storage device 925. Such instructions and data may be passed over bus 905.

System memory 915 may be a volatile read-and-write memory, such as a random access memory (RAM). The system memory may store some of the instructions and data that the processor uses at runtime. The sets of instructions and/or data used to implement some embodiments may be stored in the system memory 915, the permanent storage device 925, and/or the read-only memory 920. ROM 920 may store static data and instructions that may be used by processor 910 and/or other elements of the computer system.

Permanent storage device 925 may be a read-and-write memory device. The permanent storage device may be a non-volatile memory unit that stores instructions and data even when computer system 900 is off or unpowered. Computer system 900 may use a removable storage device and/or a remote storage device as the permanent storage device.

Input devices 930 may enable a user to communicate information to the computer system and/or manipulate various operations of the system. The input devices may include keyboards, cursor control devices, audio input devices and/or video input devices. Output devices 935 may include printers, displays, and/or audio devices. Some or all of the input and/or output devices may be wirelessly or optically connected to the computer system.

Other components 940 may perform various other functions. These functions may include performing specific functions (e.g., graphics processing, sound processing, etc.), providing storage, interfacing with external systems or components, etc.

Finally, as shown in FIG. 9, computer system 900 may be coupled to one or more networks 950 through one or more network interfaces 945. For example, computer system 900 may be coupled to a web server on the Internet such that a web browser executing on computer system 900 may interact with the web server as a user interacts with an interface that operates in the web browser. Computer system 900 may be able to access one or more remote storages 960 and one or more external components 965 through the network interface 945 and network 950. The network interface(s) 945 may include one or more APIs that may allow the computer system 900 to access remote systems and/or storages and also may allow remote systems and/or storages to access computer system 900 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 900 may be used in conjunction with some embodiments. Moreover, one of ordinary skill in the art will appreciate that many other system configurations may also be used in conjunction with some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

We claim:

1. A method for controlling content provided by a digital signage system, the method comprising:
sending (630), from the mobile device, a notification to the digital signage system if the location of the mobile device is within an area associated with the digital signage system;
receiving (640), at the mobile device, a response to the notification from the digital signage system; and
sending (670), from the mobile device, a termination message to the digital signage system if the location of the mobile device is outside the area associated with the digital signage system.

2. The method of claim 1 further comprising:
identifying a set of menu options based on the response;
providing a user interface based at least partly on the set of menu options; and
sending a command to the digital signage system based at least partly on a selection identified from among the set of menu options.

3. The method of claim 1 further comprising providing the response to at least one application running on the mobile device.

4. The method of claim 1, wherein the notification comprises at least one of biographic information related to a user of the mobile device, demographic data related to the user, a purchase history associated with the user, and a shopping list associated with the user.

5. The method of claim 1 further comprising receiving, at the mobile device, at least one marketing offer based at least partly on the notification.

6. An apparatus that provides controllable media content, the apparatus comprising:
a mobile device (110) having a geolocation sub-element able to determine a location of the mobile device;
a framework (165) that monitors the location of the mobile device, determines whether the mobile device is within an area associated with a display (120) of a digital signage system, sends, to the display, a notification if the mobile device is within the area associated with the display, receives, from the display, a response to the notification, and sends, to the display, a termination message if the mobile device is outside the area associated with the display.

7. The apparatus of claim 6, wherein the framework further identifies a set of menu options based on the response, provides a user interface based at least partly on the set of menu options, and sends a command to the digital signage system based at least partly on a selection identified from among the set of menu options.

8. The apparatus of claim 6, wherein the framework provides the response to at least one application running on the mobile device.

9. The apparatus of claim 6, wherein the notification comprises at least one of biographic information related to a user of the mobile device, demographic data related to the user, a purchase history associated with the user, and a shopping list associated with the user.

10. The apparatus of claim 6, wherein the framework receives at least one marketing offer based at least partly on the notification.

11. A method for providing advertising content via a digital signage system, the method comprising:
providing (710) media content from at least one display associated with the digital signage system;
receiving (720) a notification, from a mobile device, indicating that the mobile device is within an area associated with the at least one display, wherein the notification includes data related to a user of the mobile device;
updating (740) a knowledge base based at least partly on the notification; and
providing (750) updated media content based at least partly on the updated knowledge base.

12. The method of claim 11, wherein the data related to the user of the mobile device comprises at least one of biographic data, demographic data, a purchase history associated with the user, and a shopping list.

13. The method of claim 12 further comprising sending an offer to the mobile device based at least partly on the data related to the user.

14. The method of claim 11 further comprising:
receiving a termination message, from the mobile device, indicating that the mobile device is no longer within the area associated with the at least one display;
updating the knowledge base based at least partly on the termination message; and
providing updated media content based at least partly on the updated knowledge base.

15. The method of claim 11 further comprising:
generating a menu of options based at least partly on the data related to the user of the mobile device and content available at the at least one display;
sending the menu to the mobile device;
receiving a selection from the menu; and
updating the media content based at least partly on the selection.

16. A digital signage system that provides advertising content, the digital signage system comprising:
a storage that stores media content;
a memory that stores at least one set of instructions, wherein the at least one set of instructions are for:
providing media content from at least one display (120) associated with the digital signage system;
receiving a notification, from a mobile device (110), indicating that the mobile device is within an area associated with the at least one display, wherein the notification includes data related to a user of the mobile device;
updating a knowledge base based at least partly on the notification; and
providing updated media content from the at least one display (120) based at least partly on the updated knowledge base.

17. The digital signage system of claim 16, wherein the data related to the user of the mobile device comprises at least one of biographic data, demographic data, a purchase history associated with the user, and a shopping list.

18. The digital signage system of claim 16, wherein the at least one set of instructions further comprises sending an offer to the mobile device based at least partly on the data related to the user.

19. The digital signage system of claim 16, wherein the at least one set of instructions further comprises:
receiving a termination message, from the mobile device, indicating that the mobile device is no longer within the area associated with the at least one display;
updating the knowledge base based at least partly on the termination message; and
providing updated media content based at least partly on the updated knowledge base.

20. The digital signage system of claim 16, wherein the at least one set of instructions further comprises:
generating a menu of options based at least partly on the data related to the user of the mobile device and content available at the at least one display;
sending the menu to the mobile device;
receiving a selection from the menu; and
updating the media content based at least partly on the selection.
